(19) United States
(12) Patent Application Publication
(10) Pub. No.: US 2014/0144594 A1
(43) Pub. Date: May 29, 2014

(54) PROCESS FOR CHLORIDE REDUCTION

(71) Applicant: Dennis W. Johnson, Simpsonville, SC (US)

(72) Inventor: Dennis W. Johnson, Simpsonville, SC (US)

(21) Appl. No.: 14/115,989

(22) PCT Filed: May 4, 2012
(86) PCT No.: PCT/US2012/036502

§ 371 Date: Feb. 14, 2014

Related U.S. Application Data
(60) Provisional application No. 61/483,424, filed on May 6, 2011.

(51) Int. Cl. B01D 53/68

(52) U.S. Cl. CPC B01D 53/68
USPC 159/4.01; 95/233; 261/78.2

(57) ABSTRACT

Systems and methods are described for removing chlorides from a SOx-containing flue gas upstream of a flue gas desulfurization system. A wet sprayer can be configured to contact at least a portion of the SOx-containing flue gas with a first solution to produce (1) a SOx-containing treated flue gas that is substantially depleted of chlorides, and (2) a chloride solution product. The treated flue gas can then be fed into a flue gas desulfurization system, which allows the downstream components to comprise less-expensive materials because of the depletion of chlorides in the treated flue gas.

This application claims the benefit of priority to U.S. provisional application having Ser. No. 61/483,424 filed on May 6, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is chloride reduction processes.

### BACKGROUND

Historically, upstream chloride removal has been used for some limestone flue gas desulfurization (FGD) processes, but most limestone FGD systems simultaneously capture chlorides with SO₂ and control chloride concentration by purging a liquid stream. In typical prior art FGD systems, the gases and fluids associated with the FGD systems can be highly corrosive, and corrosion resistant materials such as hastelloy C-276 or titanium are typically used in certain downstream components. However, the use of these expensive materials increases the overall cost of the systems.

Exemplary prior art systems are discussed in U.S. Pat. No. 6,936,231 to Duncan, et al. (NOx, Hg, and SO₂ removal using ammonia); U.S. Pat. No. 7,052,662 to Duncan, et al. (NOx, Hg, and SO₂ removal using alkali hydroxide); U.S. Pat. No. 7,048,899 to Alix, et al. (Removing NOx, SO₂, and Hg from a gas stream using limestone regeneration); U.S. Pat. No. 6,991,771 to Duncan, et al. (NOx, Hg, and SO₂ removal using ammonia); U.S. Pat. No. 6,605,263 to Alix, et al. (SO₂ removal using ammonia); U.S. Pat. No. 6,132,692 to Alix, et al. (Barrier discharge conversion of SO₂ and NOx to acids); U.S. patent appl. no. 2004/0105802 to Duncan et al. (publ. June 2004) (NOx, Hg and SO₂ removal using ammonia); U.S. patent appl. no. 2003/0175190 to Duncan et al. (publ. September 2003) (NOx, Hg, and SO₂ removal using ammonia); U.S. patent appl. no. 2003/0108472 to Duncan et al. (publ. June 2003) (NOx, Hg, and SO₂ removal using alkali hydroxide); U.S. patent appl. no. 2003/0108469 to Alix et al. (publ. June 2003) (SO₂ removal using ammonia); and U.S. patent appl. no. 2003/0108466 to Alix et al. (publ. June 2003) (Removing NOx, SO₂, and Hg from a gas stream using limestone regeneration).

U.S. Pat. No. 7,524,470 to Barger et al. discusses flue gas desulfurization (“FGD”) that uses a slurry (e.g., lime or limestone FGD). Barger's system removes the chlorides downstream of the FGD and then re-injects them upstream of the FGD. This disadvantageously contacts chlorides with at least some of the components downstream of the FGD, which necessitates that those components comprise higher-cost materials.

In addition, U.S. Pat. No. 6,126,910 to Wilhelm, et al. discusses methods for removing acid gases from a flue gas by injecting a bisulfite at high temperatures. However, such injection is not used to control chlorides in the flue gas, and disadvantageously produces additional SO₂ as a byproduct, which have to be removed downstream. In addition, the use of a bisulfite adds generally adds significant on-going cost to the system.

These systems fail to appreciate that the chlorides can be removed from a SOx-containing flue gas upstream of a FGD system such that less expensive materials can be used in components downstream of the FGD system.

While U.S. Pat. No. 7,625,537 to Rader et al. contemplates the benefits of removing chlorides in a FGD process, Rader utilizes a spray dryer upstream of a filter and a wet scrubber to remove flyash. Because of the materials used to remove flyash, the dry FGD product is discarded rather than being recycled in the process. This disadvantageously increases the cost of the process.

Thus, there is still a need for systems and methods that remove chlorides from a SOx-containing flue gas upstream of a FGD system using a wet sprayer.

### SUMMARY OF THE INVENTION

The inventive subject matter provides apparatus, systems and methods for removing chlorides from a SOx-containing flue gas upstream of a flue gas desulfurization system. The advantages of these apparatus, systems and methods is that chlorides are captured upstream of the FGD, and prior to the SOx scrubbing step. By removing chlorides from the SOx-containing flue gas upstream of the FGD, the overall cost of the FGD system can be reduced by eliminating the impact of chlorides on the design and material selection of crystallizers, scrubber vessels, pipe systems and/or other downstream components of the system. In this manner, the components can comprise lower cost materials including, for example, 316 LMN, 317 LMN, Alloy 2205, and other metals and metals composites, and combinations thereof.

Contemplated systems can include a wet sprayer configured to contact at least a portion of the SOx-containing flue gas with a first solution to produce (1) a SOx-containing treated flue gas that is substantially depleted of chlorides; and (2) a chloride solution product. The SOx-containing treated flue gas can then be fed into a flue gas desulfurization system, which advantageously reduces the cost of the FGD system by eliminating or significantly reducing the impact of chlorides on the design and material selection of crystallizers, scrubber vessels, pipe systems, and other components.

As used herein, the term “substantially depleted” means less than 10 vol % of chlorides, and the term “SOx” includes SO₂ and SO₃. Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

It is contemplated that the systems, apparatus, and methods discussed herein can be used with any process that contains both chlorides and sulfur oxides, and in which (1) the chlorides and sulfur oxides are removed from the gas stream, and (2) the chlorides are concentrated in equipment downstream of the FGD that requires expensive materials such as high grade alloys. It is further contemplated that the systems, apparatus, and methods discussed herein can be used with various fossil fuel-based combustion sources such as coal fired power plants that have a chloride- and sulfur-containing fuel such as coal, and ammonia, sodium, potassium, and magnesium based FGD systems.

Preferred systems combine an FGD to include a crystallizer in the process such as the Powerspan ECO™ process, the Marsulex™ process, or the Airborne™ process. By removing chlorides upstream of the FGD, the cost of the crystallizer and other components located downstream of the FGD can be reduced because such components can be built from less expensive materials.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a prior art FGD system.

FIG. 2 is a schematic of an embodiment of a system for removing chlorides from a SOx-containing flue gas upstream of a FGD system.

FIG. 3 is a schematic of another embodiment of a system for removing chlorides from a SOx-containing flue gas upstream of a FGD system.

FIG. 4 is a flowchart of a method of treating a SOx-containing flue gas upstream of a flue gas desulfurization system.

### DETAILED DESCRIPTION

One should appreciate that the disclosed techniques provide many advantageous technical effects including the capture of chlorides upstream of a FGD system, and prior to a SOx scrubbing step. This advantageously reduces the overall cost of the system by allowing for lower cost materials to be used in components downstream of the FGD. In addition, the improvements discussed herein simplify the equipment used because of the use of solutions in almost all steps other than the crystallizer. Furthermore, the pH of the solution can be at least partially controlled by using some of the FGD reagent combined with the chloride solution removed from the flue gas.

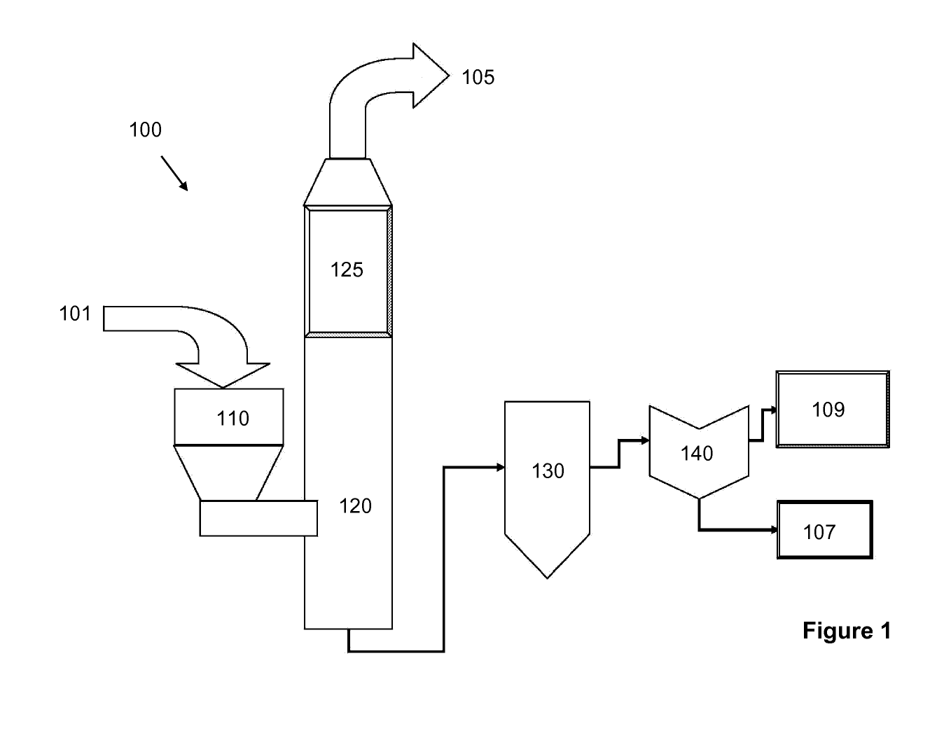

In prior art FIG. 1, a FGD system is shown having an electro-catalytic oxidation (ECO) reactor 110 that receives a flue gas stream 101 and uses a barrier discharge to convert NO to NO₂ and HNO₃. The now acidic NOx compounds are removed along with SO₂, Cl, mercury and other pollutants in a downstream ammonia-based FGD 120 equipped with a wet electrostatic precipitator (ESP) 125. A cleaned gas stream 105 can then exit the ESP 125. Because the gases downstream of the ECO reactor 110 are highly corrosive, corrosion resistant materials such as hastelloy C-276 are therefore required.

The FGD product can be fed into evaporative crystallizer 130, which concentrate the solids to produce a co-product of crystalline ammonium sulfate fertilizer 107 and a mixed aqueous fertilizer 109 of ammonium nitrate and ammonium chloride. Because concentrated chlorides are present in the crystallizer 130, a very corrosive environment is created and therefore also requires the use of corrosion resistant alloys such as titanium or hastelloy.

Thus, chlorides are present in the FGD 120, Crystallizer 130, Solids Separation Equipment 140, and conduits coupling the various components, which necessitates the use of corrosion-resistant materials and increases the overall cost of system 100.

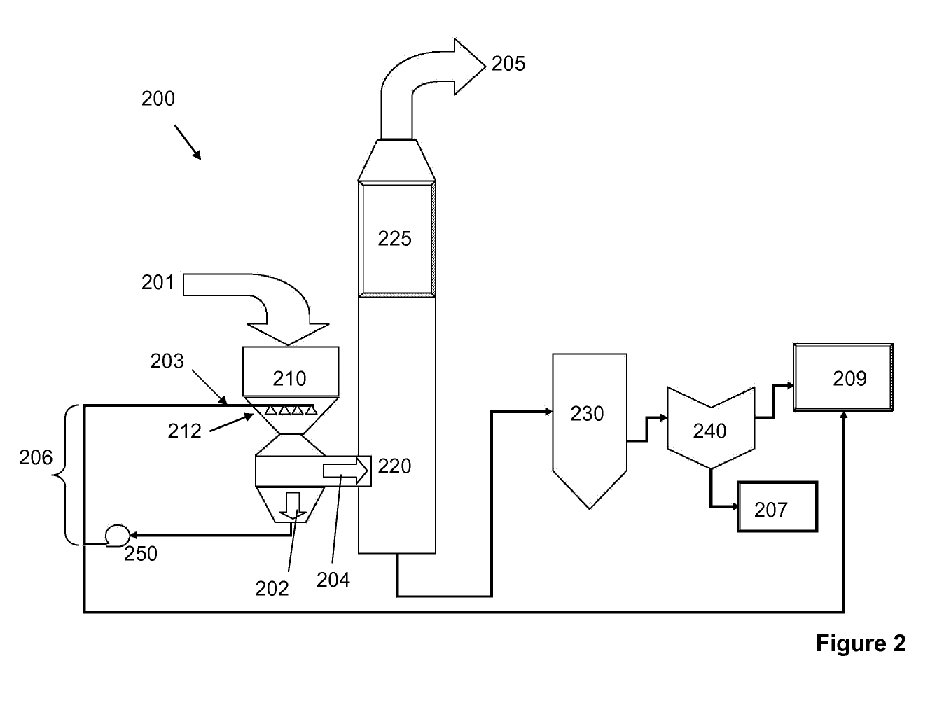

FIG. 2 illustrates an improved system 200 for removing chlorides from a SOx-containing flue gas 201 upstream of a FGD 220. The system 200 can include a wet sprayer 212 that is disposed upstream of the FGD 220, and preferably disposed downstream of an ECO reactor 210. The wet sprayer 212 can be configured to contact at least a portion of the SOx-containing flue gas 201 with a first solution 203 to produce (1) a SOx-containing treated flue gas 204 that is substantially depleted of chlorides, and (2) a chloride solution product 202. Preferably, the wet sprayer 212 is operated at conditions such that chlorides are preferentially removed from the SOx-containing flue gas 201. Other strong acid gases such as NO₂, if present, can be removed to a lesser extent, but these are secondary and minor compared to the removal of chlorides. The SOx-containing treated flue gas 204 can then be fed into the FGD 220.

In this manner, chlorides can be captured from the SOx-containing flue gas 201 prior to the gas being fed into the FGD 220, and thus chlorides are only substantially present upstream of the FGD 220. As used herein, the term “substantially present” means a concentration of more than 10 vol %. This advantageously reduces the overall cost of system 200 by eliminating the impact of chlorides on the design and material selection of the FGD 220, crystallizer 230, solids separation equipment 240, and various conduits. The FGD 220, crystallizer 230, solids separation equipment 240, and various conduits can each comprise lower cost materials including, for example, 316 LMN, 317 LMN, and Alloy 2205, and other metals or metal composites, and any combinations thereof. System 200 also takes advantage of the corrosion resistance of the materials between the ECO reactor 210 and the ammonia-based FGD 220.

The first solution 203 can comprise at least 20%, and preferably at least 30%, 40%, or 50% of water, which can be circulated within a wet sprayer circuit 206 that includes pump 250. The first solution 203 or solvent can be combined in a venturi with the chloride solution product 202, which thereby lowers the pH of the first solution 203 because of the presence of hydrochloric acid (HCl). Because HCl is a strong acid, it can be removed using water, and by removing it with the wet sprayer 212, the FGD 220 and crystallizer 230 can be simplified.

Ideally, the pH of the first solution 203 is no greater than 5.0, such that chlorides are selectively removed from the SOx-containing flue gas, and the SO₂ removal can be lessened, and preferably prevented, in the wet sprayer 212. Advantageously, the pH of the first solution can be controlled by using some of the reagent already present, either fresh or partially-used reagent, such that the pH does not become severely corrosive. As used herein, the term “selectively removed” means that 70%, 80%, and more preferably 90% or more of chlorides are captured.

At least a portion of the resulting chloride-containing first solution can be bled from circuit 206 as needed, and that portion can be handled separately or optionally combined with the aqueous ammonium nitrate produced in solids separation equipment 240 to form an aqueous ammonium nitrate and chloride solution 209. The remaining chloride-containing first solution can be recirculated to the wet sprayer 212, such that the first solution 203 comprises at least a portion of the chloride solution product 202.

The SOx-containing treated flue gas 204 that is now substantially depleted of chlorides and other acid gas compounds can be fed into the FGD 220. The FGD 220 is preferably operated under conditions that allow absorption of all remaining contaminants in the gas stream including, for example, SO₂ and remaining other acid gases, as well as chlorides but to a much lesser degree. It is contemplated that the FGD 220 can have a reagent that is highly soluble and comprising, for example, ammonia, sodium, potassium, or magnesium. The resulting product in each example from the FGD 220 would be crystallized compounds of ammonium sulfate, sodium sulfate, potassium sulfate, or magnesium sulfate, respectively.

From the FGD 220, a sulfate product can be fed into crystallizer 230, which can at least partially evaporate the solvent to allow preferential precipitation of ammonium sulfate 207 from solids separation equipment 240. The resulting more concentrated solvent preferably comprises ammonium nitrates, and chlorides and residual sulfates, and is optionally combined with the portion of the chloride-containing first solution that was bled from circuit 206 to produce a low value aqueous ammonium nitrate/chloride fertilizer 209.

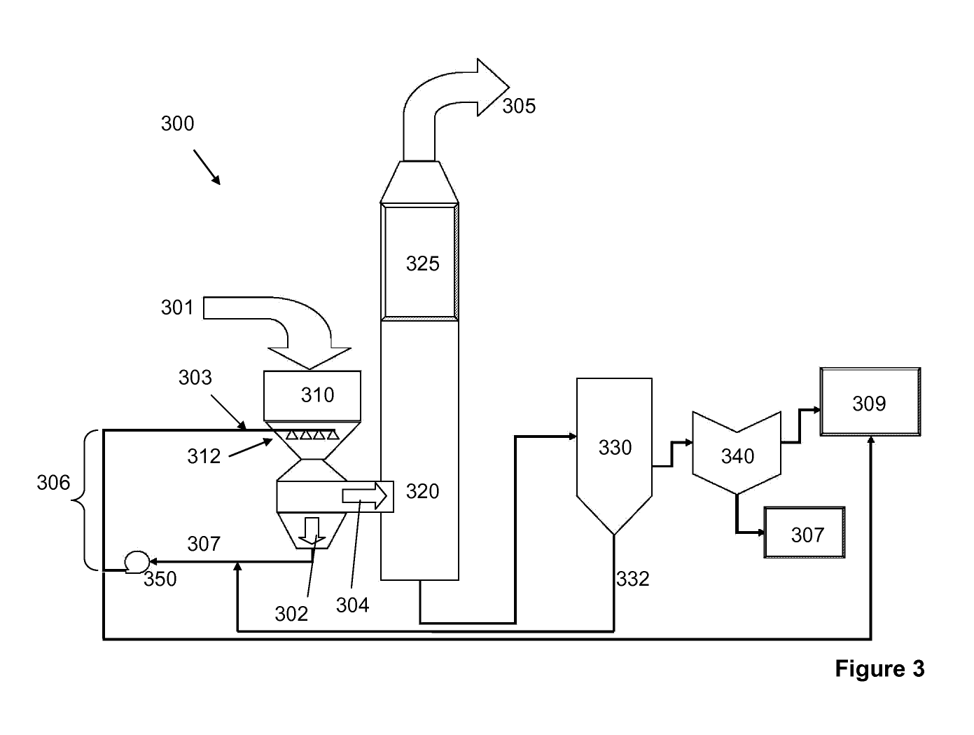

In FIG. 3, an alternative embodiment of a system 300 for removing chlorides from a SOx-containing flue gas 301 upstream of a FGD 320 is shown. The system 300 can include a crystallizer 330 in which the sulfate product from the FGD 320 can be at least partially evaporated. At least a portion of the chlorides present in the sulfate product can exit the system 300 as a purge stream 332 from crystallizer 330.

In some contemplated embodiments, at least a portion of the purge stream 332 can be mixed with at least a portion of the chloride solution product 302 to produce a second chloride solution product 307 with a controlled pH of about 5.0 or less that is recirculated with the first solution 303 to wet sprayer 312. In this manner, the first solution 303 can comprise a chloride-containing product of ammonia, potassium, sodium, and so forth, which may be salable.

It is further contemplated that at least a portion of the second chloride solution product 307 can be bled from circuit 306. With respect to the remaining numerals in FIG. 3, the same considerations for like components with like numerals of FIG. 2 apply.

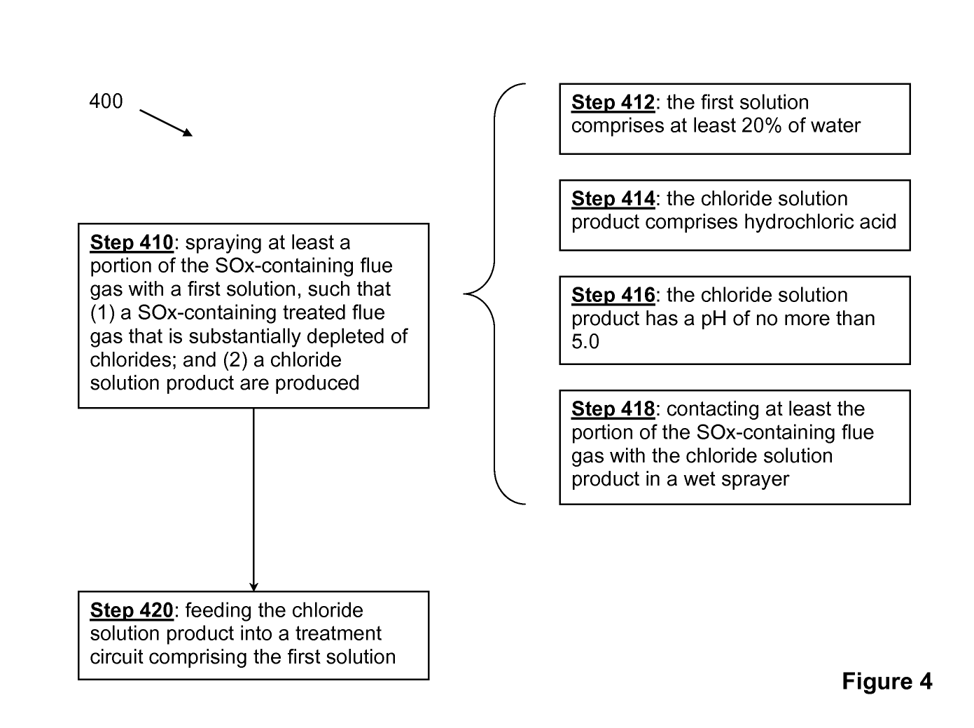

FIG. 4 illustrates a method 400 of treating a SOx-containing flue gas upstream of a flue gas desulfurization system. In step 410, at least a portion of the SOx-containing flue gas can be sprayed with a first solution, such that (1) a SOx-containing treated flue gas that is substantially depleted of chlorides; and (2) a chloride solution product are produced.

In step 412, the first solution can comprise at least 20% of water. In step 414, the chloride solution product can comprises HCl, and in step 416, the chloride solution product can have a pH of no more than 5.0.

In step 418, at least a portion of the SOx-containing flue gas can be contacted with at least a portion of the chloride solution in a wet sprayer.

In step 420, the chloride solution product can be fed into a treatment circuit comprising the first solution.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for removing chlorides from a SOx-containing flue gas upstream of a flue gas desulfurization system, comprising:
a wet sprayer configured to contact at least a portion of the SOx-containing flue gas with a first solution to produce (1) a SOx-containing treated flue gas that is substantially depleted of chlorides, and (2) a chloride solution product; and
wherein the treated flue gas is fed into a flue gas desulfurization system.

2. The system of claim 1, wherein at least a portion of the chloride solution product is mixed with the first solution, and the resulting mixture is recirculated to the wet sprayer, such that the first solution comprises at least the portion of the chloride solution product.

3. The system of claim 1, wherein the first solution comprises at least 20% of water.

4. The system of claim 1, wherein the chloride solution product comprises hydrochloric acid.

5. The system of claim 1, wherein the chloride solution product has a pH of no more than 5.0.

6. The system of claim 1, wherein the flue gas desulfurization system comprises a crystallizer.

7. The system of claim 6, wherein the SOx-containing treated flue gas enters the flue gas desulfurization system, and at least a portion of chlorides present in the SOx-containing treated flue gas is captured by the flue gas desulfurization system and exits the flue gas desulfurization system as a purge stream from the crystallizer.

8. The system of claim 7, wherein at least a portion of the purge stream is mixed with at least a portion of the chloride solution product to produce a second chloride solution product that is recirculated to the wet sprayer.

9. The system of claim 8, wherein at least a portion of the second chloride solution product is purged from the second chloride solution product as a byproduct.

10. A treatment circuit for a SOx-containing flue gas, comprising:
a solvent;
a pump configured to circulate the solvent; and
wherein the solvent has a pH such that the solvent selectively removes chlorides from the SOx-containing flue gas.

11. The treatment circuit of claim 10, wherein the solvent comprises at least 20% of water.

12. The treatment circuit of claim 10, wherein the pH of the solvent is no greater than 5.0.

13. A method of treating a SOx-containing flue gas upstream of a flue gas desulfurization system, comprising:
spraying at least a portion of the SOx-containing flue gas with a first solution, such that (1) a SOx-containing treated flue gas that is substantially depleted of chlorides, and (2) a chloride solution product are produced; and
feeding the chloride solution product into a treatment circuit comprising the first solution.

14. The method of claim 13, wherein the first solution comprises at least 20% of water.

15. The method of claim 13, wherein the chloride solution product comprises hydrochloric acid.

16. The method of claim 13, wherein the chloride solution product has a pH of no more than 5.0.

17. The method of claim 13, wherein the step of spraying at least the portion of the SOx-containing flue gas further comprises contacting at least the portion of the SOx-containing flue gas with the chloride solution product in a wet sprayer.
